(19) United States
(12) Patent Application Publication
(10) Pub. No.: US 2006/0012779 A1
(43) Pub. Date: Jan. 19, 2006

(54) Lithographic apparatus and device manufacturing method

(75) Inventors: Paul Christiaan Hinnen, Veldhoven (NL); Richard Johannes Franciscus Van Haren, Waalre (NL); Hubertus Johannes Gertrudus Simons, Venlo (NL)

Correspondence Address: STERNE, KESSLER, GOLDSTEIN & FOX PLLC, 1100 NEW YORK AVENUE, N.W., WASHINGTON, DC, 20005, US

(73) Assignee: ASML Netherlands B.V., Veldhoven (NL)

(21) Appl. No.: 11/050,457

(22) Filed: Feb. 4, 2005

Related U.S. Application Data
(63) Continuation-in-part of application No. 10/889,211, filed on Jul. 13, 2004.

(51) Int. Cl. G01N 21/00

(52) U.S. Cl. 356/237.4

(57) ABSTRACT

A lithographic apparatus and method comprise an illumination system arranged to provide a radiation beam, a support structure configured to support a product patterning device and a metrology target patterning device. The product patterning device imparts a radiation beam derived from the illumination system with a product pattern in its cross-section representing features of a product device to be formed. The metrology target patterning device imparts the radiation beam with a metrology target pattern in its cross-section representing at least one metrology target. The product patterning device is separate from the metrology target patterning device. A substrate table holds a substrate. A projection system project the radiation patterned by the product patterning device and the metrology target patterning device onto a target portion of the substrate. A metrology target patterning device controller adjusts the metrology target pattern independently of the product pattern.

### CROSS REFERENCE TO RELATED APPLICATIONS

This application is a continuation-in-part of U.S. Ser. No. 10/889,211, filed Jul. 13, 2004, which is incorporated by reference herein in its entirety.

### BACKGROUND

1. Field of the Invention

The present invention relates to a lithographic apparatus and a device manufacturing method.

2. Related Art

A lithographic apparatus is a machine that applies a desired pattern onto a target portion of a substrate. The lithographic apparatus can be used, for example, in the manufacture of integrated circuits (ICs), flat panel displays, and other devices involving fine structures. In a conventional lithographic apparatus, a patterning means, which is alternatively referred to as a mask or a reticle, may be used to generate a circuit pattern corresponding to an individual layer of the IC (or other device), and this pattern can be imaged onto a target portion (e.g., comprising part of one or several dies) on a substrate (e.g., a silicon wafer or glass plate) that has a layer of radiation-sensitive material (e.g., resist). Instead of a mask, the patterning means may comprise an array of individually controllable elements that generate the circuit pattern. For example, the patterning means can be, but is not limited to, a reflective or transmissive contrast device, such as a spatial light modulator, a digital mirror device, a grating light valve, a liquid crystal display, or the like.

In general, a single substrate will contain a network of adjacent target portions that are successively exposed. Known lithographic apparatus include steppers, in which each target portion is irradiated by exposing a pattern onto the target portion in each exposure period. Other known lithographic apparatus include scanners, in which each target portion is irradiated by scanning the pattern through the projection beam in a given direction (the “scanning” direction), while synchronously scanning the substrate parallel or anti-parallel to this direction.

A metrology target generally refers to a type of target that may form part of the pattern written to the substrate, but which does not actually contribute directly to the functional or structural form of the device being manufactured. Usually, the function of a metrology target is to facilitate aspects of the manufacturing process itself, such as alignment of a substrate to the projection system, verification of overlay and/or imaging properties, etc. Metrology targets may therefore include alignment marks and targets used in “offline” metrology equipment associated with or within the lithography apparatus. Offline generally refers to metrology equipment designed to process a substrate separately from, and at a different time to, the main lithography processes used to pattern the substrate, while inline metrology refers to processes carried out at the same time and/or position. For the purposes of this description, protective structures for the above alignment marks and targets are themselves to be understood as types of metrology target.

In one example using mask-based systems, the metrology targets normally have to be defined before the mask is actually made. If it turns out that in manufacturing conditions the metrology target design is non-optimal, e.g., for overlay performance, a new mask or set of masks has to be produced before an improved metrology target design can be implemented. This hampers the speed at which the potential of new metrology target designs can be evaluated and leads to increased costs for the customer.

In another example, using either mask-based or maskless systems, variation between substrates within a batch to be exposed can mean that metrology information derived inline from one substrate can not accurately represent the characteristics of a following substrate. In such a situation, the exposure settings set for the second substrate, based on inspection of the first substrate, can not be optimal. This can be solved by re-working each substrate after metrology target inspection so that it can be printed a second time with the optimal exposure settings. However, this re-working process reduces the efficiency of the apparatus and requires complex substrate handling apparatus.

Therefore, what is needed is a system and method that can optimize performance of metrology targets in lithographic devices. Additionally or alternatively, what is needed is a system and a method that can add flexibility in the choice of metrology target even after the product design has been finalized. Additionally or alternatively, what is needed is an efficient system for providing exposure settings when substrate properties vary within a batch.

### SUMMARY

An embodiment of the present invention provides a device manufacturing method comprising the following steps. A first exposure comprising exposing a substrate to a first pattern for forming one or more metrology targets. Inspecting a latent image of the one or more metrology targets formed on the substrate and deriving therefrom an improved set of exposure settings. A second exposure comprising exposing the substrate to a second pattern for forming one or more product device features. The second exposure is carried out using the improved set of exposure settings.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form apart of the specification, illustrate the present invention and, together with the description, further serve to explain the principles of the invention and to enable a person skilled in the pertinent art to make and use the invention.

FIG. 1 depicts a lithographic apparatus, according to one embodiment of the invention.

FIG. 2a depicts a lithographic apparatus comprising a first exemplary arrangement of a product patterning device and a metrology target patterning according to one embodiment of the invention.

FIG. 2b depicts a lithographic apparatus comprising a second exemplary arrangement of a product patterning device and a metrology target patterning, according to one embodiment of the invention.

FIG. 3 depicts an alternative configuration of a lithographic, according to one embodiment of the invention, where the metrology target patterning device comprises an array of individually controllable elements.

FIG. 4 depicts a metrology target optimizing feedback loop, according to one embodiment of the invention.

FIG. 5 depicts an arrangement of metrology targets of different types on different target portions of a substrate, according to one embodiment of the invention.

FIG. 6 depicts an example metrology target design comprising a primary structure and a substructure, according to one embodiment of the invention.

FIG. 7 depicts protective structures for metrology targets positioned in the scribe lane, according to one embodiment of the invention.

FIG. 8 depicts protective structures for metrology targets positioned in the region between the dies and the edge of the substrate, according to one embodiment of the invention.

FIG. 9 depicts positioning of metrology targets to minimize cross-talk with product features, according to one embodiment of the invention.

FIG. 10 depicts a lithographic apparatus, according to one embodiment of the invention, comprising a control system for an array of individually controllable elements and a metrology target verification and adaptation device.

FIGS. 11a and 11b depict a die and collection of dies with metrology target patterns only, according to one embodiment of the present invention.

FIGS. 12a and 12b depict the die and collection of dies of FIGS. 11a and 11b with product patterns and metrology target patterns after a second exposure with improved exposure settings, according to one embodiment of the present invention.

FIG. 13 depicts a lithography apparatus configured to print metrology targets only, derive improved exposure settings from inspection of a latent image of metrology targets, and then print product patterns with the new exposure settings, according to one embodiment of the present invention.

The present invention will now be described with reference to the accompanying drawings. In the drawings, like reference numbers can indicate identical or functionally similar elements.

### DETAILED DESCRIPTION OF THE EMBODIMENTS

### Overview and Terminology

Although specific reference can be made in this text to the use of lithographic apparatus in the manufacture of integrated circuits (ICs), it should be understood that the lithographic apparatus described herein can have other applications, such as the manufacture of integrated optical systems, guidance and detection patterns for magnetic domain memories, flat panel displays, thin-film magnetic heads, etc. The skilled artisan will appreciate that, in the context of such alternative applications, any use of the terms “wafer” or “die” herein can be considered as synonymous with the more general terms “substrate” or “target portion,” respectively. The substrate referred to herein can be processed, before or after exposure, in for example a track (e.g., a tool that typically applies a layer of resist to a substrate and develops the exposed resist) or a metrology or inspection tool. Where applicable, the disclosure herein can be applied to such and other substrate processing tools. Further, the substrate can be processed more than once, for example in order to create a multi-layer IC, so that the term substrate used herein can also refer to a substrate that already contains multiple processed layers.

The terms “radiation” and “beam” used herein encompass all types of electromagnetic radiation, including ultraviolet (UV) radiation (e.g., having a wavelength of 365, 355, 248, 193, 157 or 126 nm) and extreme ultra-violet (EUV) radiation (e.g., having a wavelength in the range of 5-20 nm), as well as particle beams, such as ion beams or electron beams.

The term “projection system” used herein should be broadly interpreted as encompassing various types of projection systems, including refractive optical systems, reflective optical systems, and catadioptric optical systems, as appropriate, for example, for the exposure radiation being used, or for other factors such as the use of an immersion fluid or the use of a vacuum. Any use of the term “lens” herein can be considered as synonymous with the more general term “projection system.”

The term “patterning means” used herein should be broadly interpreted as referring to means that can be used to impart a radiation beam with a pattern in its cross-section such as to create a pattern in a target portion of the substrate. It should be noted that the pattern imparted to the radiation beam can not exactly correspond to the desired pattern in the target portion of the substrate. Generally, the pattern imparted to the radiation beam will correspond to a particular functional layer in a device being created in the target portion, such as an integrated circuit.

Patterning means can be transmissive or reflective. Examples of patterning means include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned. In each example of patterning means, the support structure can be a frame or table, for example, which can be fixed or movable as required and which can ensure that the patterning means is at a desired position, for example with respect to the projection system. Any use of the terms “reticle” or “mask” herein can be considered synonymous with the more general term “patterning means”.

The illumination system can also encompass various types of optical components, including refractive, reflective, and catadioptric optical components for directing, shaping, or controlling the projection beam of radiation, and such components can also be referred to below, collectively or singularly, as a “lens.”

The lithographic apparatus can be of a type having two (e.g., dual stage) or more substrate tables (and/or two or more mask tables). In such “multiple stage” machines the additional tables can be used in parallel, or preparatory steps can be carried out on one or more tables while one or more other tables are being used for exposure.

The lithographic apparatus can also be of a type wherein the substrate is immersed in a liquid having a relatively high refractive index (e.g., water), so as to fill a space between the final element of the projection system and the substrate. Immersion liquids can also be applied to other spaces in the lithographic apparatus, for example, between the substrate and the first element of the projection system. Immersion techniques are well known in the art for increasing the numerical aperture of projection systems.

Further, the apparatus can be provided with a fluid processing cell to allow interactions between a fluid and irradiated parts of the substrate (e.g., to selectively attach chemicals to the substrate or to selectively modify the surface structure of the substrate).

### Exemplary Lithography System

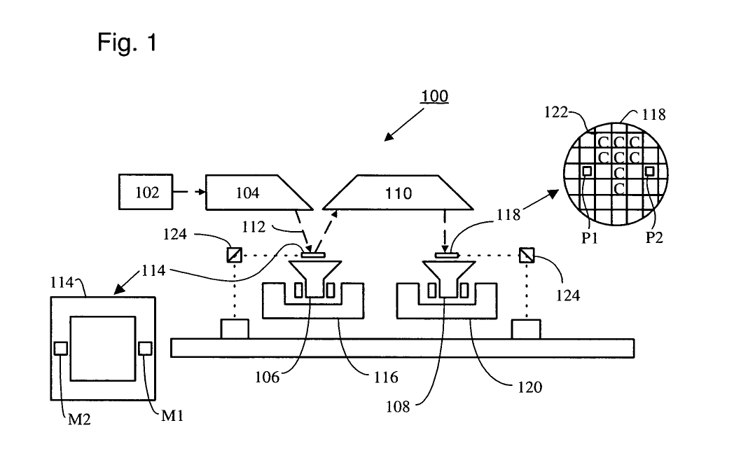

FIG. 1 schematically depicts a lithographic apparatus 100, according to one particular embodiment of the invention. Lithographic apparatus comprises a radiation source 102, an illumination system 104, a first support structure 106, a substrate table 108, and a projection system 110.

Illumination system 104 (e.g., an illuminator) provides a radiation beam 112 comprising, for example, ultra violet (UV) or extreme ultra violet (EUV) radiation. Illuminator 104 receives a radiation beam from radiation source 102.

First support structure 106 (e.g. a mask table) supports a patterning means 114 (e.g. a mask) and is connected to a first positioning means 116 for accurately positioning patterning means 114 with respect to projection system 110.

Substrate table 108 (e.g. a wafer table) holds a substrate 118 (e.g. a resist-coated wafer) and is connected to a second positioning means 120 that accurately positions substrate 118 with respect projection system 110.

Projection system 110 (e.g. a reflective projection lens) images a pattern imparted to radiation beam 112 via patterning means 114 onto a target portion 122 (C) (e.g. one or more dies) of substrate 118.

In this embodiment, lithographic apparatus 100 is of a reflective type (e.g., employing a reflective mask or a programmable mirror array of a type as referred to above). Alternatively, lithographic apparatus 100 can be of a transmissive type (e.g., employing a transmissive mask).

In one embodiment, source 102 and lithographic apparatus 100 can be separate entities. For example, when source 102 is a plasma discharge source. In such cases, source 102 is not considered to form part of lithographic apparatus 100, and radiation beam 112 is generally passed from source 102 to illuminator 104 with the aid of a radiation collector (not shown). The radiation collector can comprise, for example, but not limited to, suitable collecting mirrors and/or a spectral purity filter.

In other cases source 102 can be integral part of apparatus 100. For example, when source 102 is a mercury lamp.

In one example, source 102 and illuminator 104 can be referred to as a radiation system.

Illuminator 104 can comprise adjusting means (not shown) that adjust an angular intensity distribution of beam 112. Generally, at least the outer and/or inner radial extent (commonly referred to as σ-outer and σ-inner, respectively) of the intensity distribution in a pupil plane of illuminator 102 can be adjusted. Illuminator 102 provides a conditioned beam of radiation, referred to as radiation beam 112, having a desired uniformity and intensity distribution in its cross-section.

Radiation beam 112 is incident on mask 114, which is held on mask table 106. Being reflected by mask 114, radiation beam 112 passes through projection system 110, which focuses the beam onto target portion C of substrate 118. With the aid of second positioning means 120 and a position sensor 124 (e.g. an interferometric device), substrate table 108 can be moved accurately, e.g. so as to position different target portions C in the path of beam 112. Similarly, first positioning means 116 and a position sensor 126 can be used to accurately position mask 114 with respect to the path of beam 112, e.g. after mechanical retrieval from a mask library, or during a scan. In general, movement of object tables 106 and 108 will be realized with the aid of a long-stroke module (coarse positioning) (not shown) and a short-stroke module (fine positioning) (not shown), which form part of positioning means 116 and 120. However, in the case of a stepper (as opposed to a scanner) mask table 116 can be connected to a short stroke actuator only, or can be fixed. Mask 114 and substrate 118 can be aligned using mask alignment marks M1, M2 and substrate alignment marks P1, P2, respectively.

In various example, apparatus 100 can be used step, scan, or other modes, examples of which are described below, but are not to be seen as an exhaustive list.

In step mode, mask table 106 and substrate table 108 are kept essentially stationary, while an entire pattern imparted to radiation beam 112 is projected onto a target portion C in one go (i.e., a single static exposure). Substrate table 108 is then shifted in the X and/or Y direction so that a different target portion C can be exposed. In step mode, a maximum size of the exposure field limits the size of the target portion C imaged in a single static exposure.

In scan mode, mask table 106 and substrate table 108 are scanned synchronously, while a pattern imparted to radiation beam 112 is projected onto a target portion C (i.e., a single dynamic exposure). A velocity and direction of substrate table 108 relative to mask table 106 is determined by (de-)magnification and image reversal characteristics of projection system 110. In scan mode, a maximum size of an exposure field limits a width (in the non-scanning direction) of target portion C in a single dynamic exposure, whereas a length of the scanning motion determines a height (in the scanning direction) of target portion C.

In another mode, mask table 106 is kept essentially stationary holding a programmable patterning means, and substrate table 108 is moved or scanned, while a pattern imparted to radiation beam 112 is projected onto target portion C. In this mode, generally a pulsed radiation source 102 is employed and patterning means 114 is updated as required after each movement of substrate table 108 or in between successive radiation pulses during a scan. This mode of operation can be readily applied to maskless lithography that utilizes a programmable patterning means for patterning means 114, for example, but not limited to, a programmable mirror array of a type as referred to above.

Combinations and/or variations on the above described modes of use or entirely different modes of use can also be employed.

Exemplary Product and Target Patterning Means Arrangements

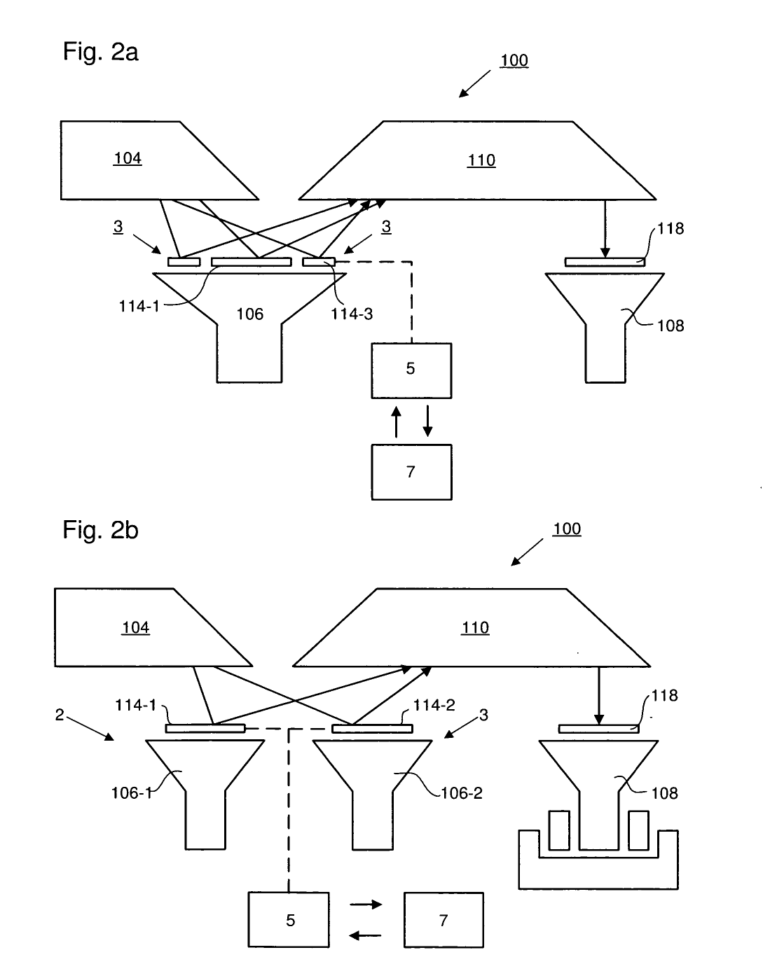

FIGS. 2a and 2b are close-up views of a lithographic apparatus 100 in a region of one or more mask tables 106, according to one embodiment of the invention. Two alternative arrangements are shown in which lithographic apparatus 100 comprises a product patterning device 2, for example a mask, and a metrology target patterning device 3, for example a mask.

In one exemplary arrangement, shown in FIG. 2a, mask table 106 is configured to support a product patterning mask 114-1 and one or more metrology target patterning masks 114-3.

In one exemplary arrangement, shown in FIG. 2b, two mask tables 106-1 and 106-2 are used. Mask table 106-1 supports product patterning mask 114-1 and mask table 106-2 supports metrology target patterning mask 114-2.

The patterning masks 114-1, 114-2, and 114-3 are arranged to impart a pattern in the cross-section of radiation beam 112 generated by illumination system 104.

Although a single radiation source 102 is illustrated in FIG. 1, illumination system 104 can comprise a plurality of radiation sources 102. For example, this can be done to provide initially separate radiation beams 112 to be patterned by product patterning mask 114-1 and metrology target patterning mask 114-2/114-3. In one example using product patterning mask 114-1, this will correspond to functional or structural features in a layer of the product being manufactured, whereas for target patterning masks 114-2 and 114-3, the pattern will correspond to metrology targets. For example, metrology targets can be, but are not limited to, alignment marks to align one patterned layer on substrate 118 with another, to align substrate 118 itself relative to projection system 110, or for other functions.

In each of the arrangements shown in FIGS. 2a and 2b, the metrology target patterning mask(s) 114-2 and 114-3 can be operated (e.g., exchanged, etc.) independently from product patterning mask 114-1. This arrangement allows for development of the metrology target design in product-like circumstances (i.e., during one of the normal stages of product manufacture) rather than in a separate procedure dedicated solely to metrology target improvement. In each case, they can interact with a mask storage device controller 5, which executes mask exchange with a mask storage device 7.

Second Exemplary Lithography Apparatus

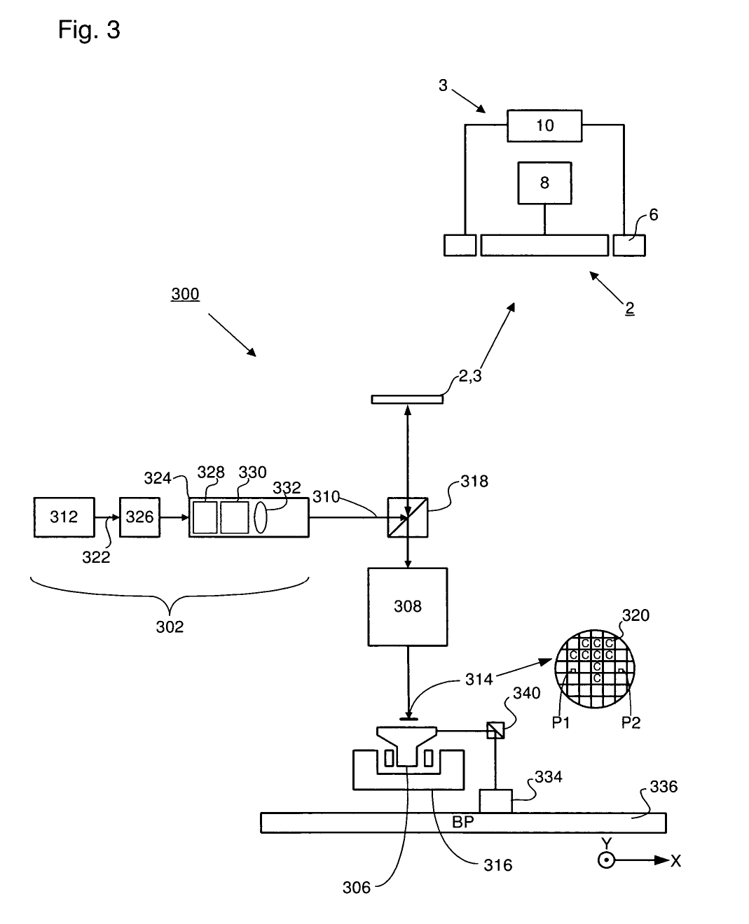

FIG. 3 schematically depicts a lithographic projection apparatus 300 according to an embodiment of the invention. In this embodiment, patterning devices 2 and 3 comprises an array of individually controllable elements 6 (e.g., a programmable mirror array, a grating light valve, a liquid crystal display, a digital mirror device, or the light contrast device or pattern generator) for applying a pattern to radiation beam 110.

Apparatus 300 includes at least a radiation system 302, patterning devices 2 and 3, an object table 306 (e.g., a substrate table), and a projection system (“lens”) 308.

Radiation system 302 can be used for supplying a projection beam 310 of radiation (e.g., UV radiation), which in this particular case also comprises a radiation source 312.

An array of patterning devices 2 and 3 (e.g., a programmable mirror array) can be used for applying a pattern to projection beam 310. In general, the position of the array of patterning devices 2 and 3 can be fixed relative to projection system 308. However, in an alternative arrangement, an array of patterning devices 2 and 3 can be connected to a positioning device (not shown) for accurately positioning it with respect to projection system 308. As here depicted, patterning devices 2 and 3 are of a reflective type (e.g., have a reflective array of individually controllable elements).

Object table 306 can be provided with a substrate holder (not specifically shown) for holding a substrate 314 (e.g., a resist coated silicon wafer or glass substrate) and object table 306 can be connected to a positioning device 316 for accurately positioning substrate 314 with respect to projection system 308.

Projection system 308 (e.g., a quartz and/or (CaF2 lens system or a catadioptric system comprising lens elements made from such materials, or a mirror system) can be used for projecting the patterned beam received from a beam splitter 318 onto a target portion 320 (e.g., one or more dies) of substrate 314. Projection system 308 can project an image of the array of patterning devices 2 and 3 onto substrate 314. Alternatively, projection system 308 can project images of secondary sources for which the elements of the array of patterning devices 2 and 3 act as shutters. Projection system 308 can also comprise a micro lens array (MLA) to form the secondary sources and to project microspots onto substrate 314.

Source 312 (e.g., an excimer laser) can produce a beam of radiation 322. Beam 322 is fed into an illumination system (illuminator) 324, either directly or after having traversed conditioning device 326, such as a beam expander 326, for example. Illuminator 324 can comprise an adjusting device 328 for setting the outer and/or inner radial extent (commonly referred to as σ-outer and σ-inner, respectively) of the intensity distribution in beam 322. In addition, illuminator 324 will generally include various other components, such as an integrator 330 and a condenser 332. In this way, projection beam 310 impinging on the array of patterning devices 2 and 3 has a desired uniformity and intensity distribution in its cross section.

It should be noted, with regard to FIG. 3, that source 312 can be within the housing of lithographic projection apparatus 300 (as is often the case when source 312 is a mercury lamp, for example). In alternative embodiments, source 312 can also be remote from lithographic projection apparatus 300. In this case, radiation beam 322 would be directed into apparatus 300 (e.g., with the aid of suitable directing mirrors). This latter scenario is often the case when source 312 is an excimer laser. It is to be appreciated that both of these scenarios are contemplated within the scope of the present invention.

Beam 310 subsequently intercepts the array of patterning devices 2 and 3 after being directing using beam splitter 318. Having been reflected by the array of patterning devices 2 and 3, beam 310 passes through projection system 308, which focuses beam 310 onto a target portion 320 of the substrate 314.

With the aid of positioning device 316 (and optionally interferometric measuring device 334 on a base plate 336 that receives interferometric beams 338 via beam splitter 340), substrate table 306 can be moved accurately, so as to position different target portions 320 in the path of beam 310. Where used, the positioning device for the array of patterning devices 2 and 3 can be used to accurately correct the position of the array of patterning devices 2 and 3 with respect to the path of beam 310, e.g., during a scan. In general, movement of object table 306 is realized with the aid of a long-stroke module (course positioning) and a short-stroke module (fine positioning), which are not explicitly depicted in FIG. 3. A similar system can also be used to position the array of patterning devices 2 and 3. It will be appreciated that projection beam 310 can alternatively/additionally be moveable, while object table 306 and/or the array of patterning devices 2 and 3 can have a fixed position to provide the required relative movement.

In an alternative configuration of the embodiment, substrate table 306 can be fixed, with substrate 314 being moveable over substrate table 306. Where this is done, substrate table 306 is provided with a multitude of openings on a flat uppermost surface, gas being fed through the openings to provide a gas cushion which is capable of supporting substrate 314. This is conventionally referred to as an air bearing arrangement. Substrate 314 is moved over substrate table 306 using one or more actuators (not shown), which are capable of accurately positioning substrate 314 with respect to the path of beam 310. Alternatively, substrate 314 can be moved over substrate table 306 by selectively starting and stopping the passage of gas through the openings.

Although lithography apparatus 300 according to the invention is herein described as being for exposing a resist on a substrate, it will be appreciated that the invention is not limited to this use and apparatus 300 can be used to project a patterned projection beam 310 for use in resistless lithography.

In one example, at least one of patterning devices 2 and 3 comprises an array of individually controllable elements. In general, a position of patterning devices 2 and 3 will be fixed relative to projection system 308. However, in other examples, at least one patterning device 2 or 3 can instead be connected to a positioning means for accurately positioning them with respect to projection system 308.

In one example, as shown in FIG. 3, metrology target patterning device 6 comprises an array of individually controllable elements. Target patterning device 6 is connected to a metrology target patterning device controller 10, which is configured to update a pattern represented by the array of individually controllable elements by determining and changing, if necessary, an activation state of each element in the array of individually controllable elements.

In one example, product patterning device 2 comprises a reflective mask 4, which is supported and controlled by a mask table and controller 8.

In one example, product patterning device 2 can also be arranged to comprise an array of individually controllable elements, in which case item 8 would function in a similar fashion to the metrology target patterning device controller 10.

In one or more examples or embodiments, patterning the metrology targets using an array of individually controllable elements, independently from whichever process is used to pattern the product features, allows more efficient updates to be made to the metrology targets without affecting the throughput achieved in the product manufacturing cycle.

It is generally difficult to predict in advance how well a given metrology target will perform in practice. Performance can be improved by fine-tuning the properties of the metrology target, but this would normally require substantial expense and loss of time, particularly if a new reticle set has to be produced for each change of metrology target and if device/product manufacturing processes have to be interrupted and/or delayed in order to carry out these processes. One or more examples or embodiments of the present invention improves the situation by separating the metrology target pattern from the product feature pattern and, particularly where an array of individually controllable elements is used, facilitating the process of changing a metrology target pattern.

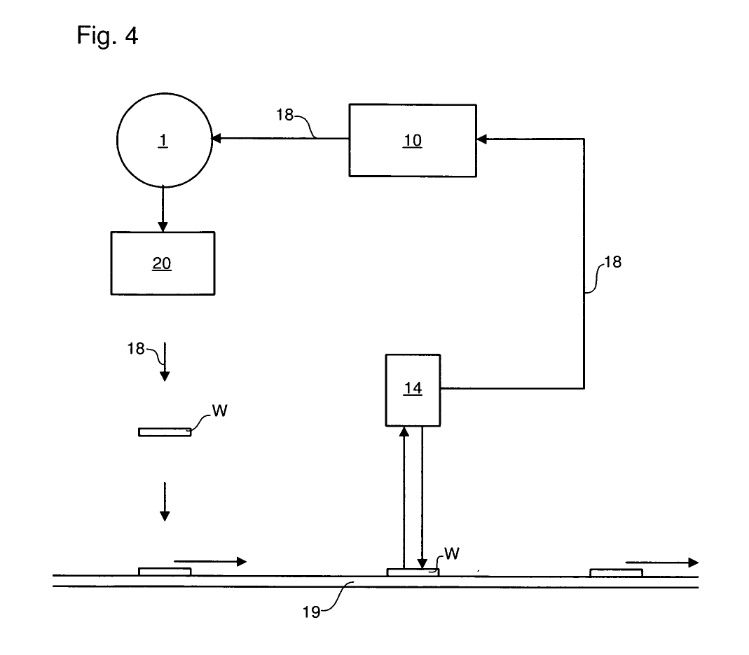

FIG. 4 depicts a metrology target optimizing feedback loop, according to one embodiment of the invention. This figure shows an arrangement of a metrology target patterning device controller 10, which is arranged to interact with a feedback loop 18. Lithography apparatus 1, according to one embodiment of the invention, is arranged to print a pattern including at least one metrology target to a substrate W. Patterned substrate W is processed via processing station 20 to develop the metrology target(s) ready for testing. A substrate transportation device 19 is used to carry developed substrates W from processing station 20 to an inspection position to be inspected using a probe 14, which is arranged to test the metrology target performance and send feedback to metrology target patterning device controller 10. Based on information thus received, metrology target patterning device controller 10 calculates a correction to send to lithography apparatus 1 to prompt a change in the pattern imparted to the radiation beam by metrology target patterning device 3.

In this embodiment, substrates developed with the updated metrology target are tested in the same way, and the cycle continues until the performance of the metrology targets falls within predetermined bounds of acceptability. The efficiency of this system allows not only optimization of metrology targets of a standard design type, but, because a larger number of trials are possible, also facilitates broader evaluation of alternative metrology target types.

Exemplary Arrangement of Metrology Targets

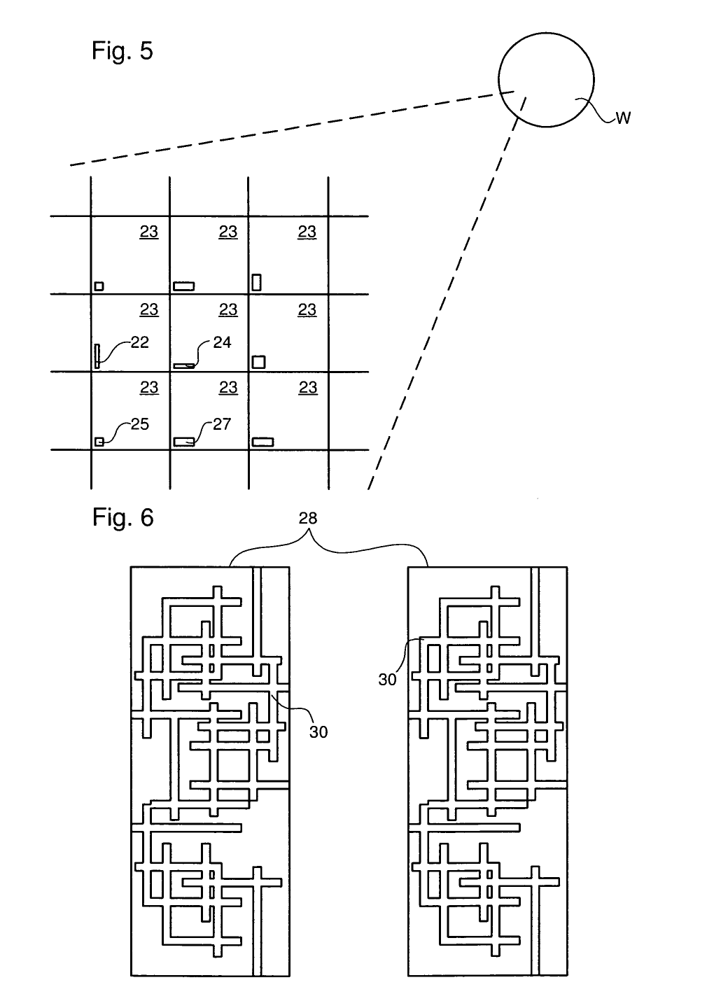

FIG. 5 depicts an arrangement of metrology targets of different types on different target portions of a substrate, according to one embodiment of the invention. In FIG. 5, metrology targets 22, 24, 25 and 27 of different types, which are illustrated schematically in the figure, but can in practice comprise a variety of designs, such as boxes, chevrons, horizontal or vertical gratings, etc., are arranged in different dies 23 on the substrate W.

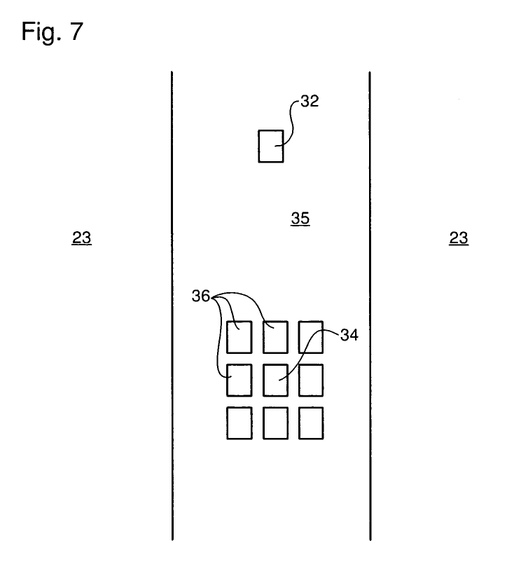

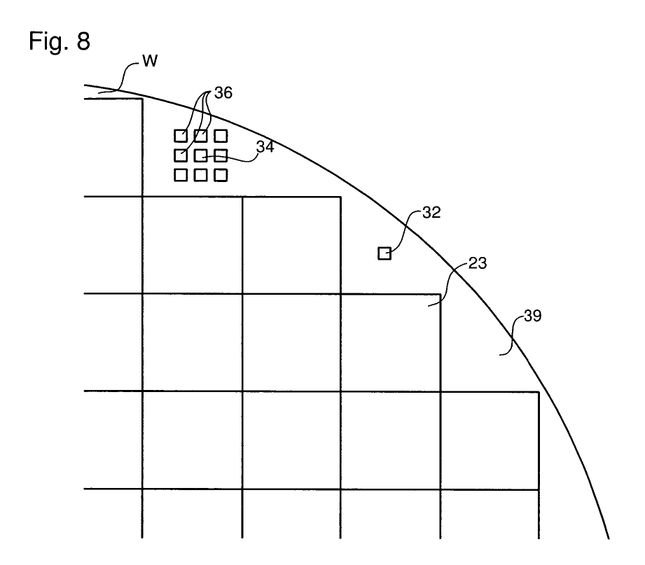

In one example, metrology targets 22, 24, 25, and 27 can be confined to a metrology target region (e.g., regions 35 and 39 in FIGS. 7 and 8, for example) around a periphery of the substrate W or along scribe lanes between dies.

However, in other examples, metrology targets 22, 24, 25, and 27 can be distributed in a more complex fashion over the surface of the substrate W.

The number and size of metrology targets is limited by space considerations, since they sometimes take up room that might otherwise be used for product features. However, it is desirable that metrology targets be of a certain minimum size and that a plurality of different metrology target designs be printed. In a testing context, for example, to see which locations suffer least from cross-talk, this can be to allow more designs to be evaluated per substrate W. More generally, a number of metrology targets will be required to perform the variety of metrology steps required for accurate lithography. Another reason can be to include metrology target standards from a number of different manufacturers in order to allow different layers to be printed by different machines.

Various embodiments and/or examples of the present invention address the problem of limited space for the metrology targets. For example, a separately controllable metrology target patterning device 3, which allows the metrology target to be easily varied, such as between one die and the next, without changing the pattern imparted by product patterning device 2. High throughput can thus be maintained and, in the case where the metrology target is changed between one die and the next, unnecessary repetition of targets between dies is avoided, thus saving space without reducing the number of metrology targets used. For example, where it is necessary to have separate coarse and fine alignment marks, these can be located in corresponding regions of different dies. In this case, two types of exposure die would exist: a first for printing the product and the fine alignment mark, and a second for printing the product and the coarse alignment mark. The occupied area for the metrology marks is the same in each case and space is therefore saved.

FIG. 6 depicts an example metrology target design comprising a primary structure and a substructure, according to one embodiment of the invention. There are various types of metrology targets are likely to be useful. The performance of a given metrology target can be enhanced by including substructure in addition to the primary structure. An example of such an arrangement is shown in FIG. 6, which depicts a grating consisting of vertical lines 28 as a primary structure with a product-like pattern superimposed as a substructure 30. In one example, substructure 30 can be at a relative length scale much smaller than that shown, which is intended for illustrative purposes.

In one example, when the metrology targets are used for alignment, they can be inspected at longer wavelengths than that used to image the product features, so that substructure 30 becomes invisible and does not interfere adversely with the operation of the metrology target as a whole. However, the presence of the product-like features ensures that the metrology targets image in a similar way to the actual product features of the device to be formed and do not suffer from different shifts or errors in the projection system.

FIG. 7 depicts protective structures for metrology targets positioned in the scribe lane, according to one embodiment of the invention. In one example, when metrology targets are positioned in isolated regions of the substrate or in areas with a significantly lower than average density of features, the metrology target can be vulnerable to excessive chemical or mechanical attack. This situation is illustrated in FIG. 7, where a metrology target 32 is isolated in a scribe lane 35 between dies 23. The lower portion of FIG. 7 illustrates how a similar metrology target 34 can be protected, according to one embodiment of the present invention by printing copies of a same metrology target 36 in a configuration surrounding target 34.

Copies of the metrology target are shown in this example because this is an approach that can be favored economically to limit the overhead costs associated with applying protective structures, i.e., no new types of marks need to be made available.

It is to be appreciated that alternative structures can be used, particularly where it is possible to produce such structures without change to the product pattern.

In one example, dedicated protective structures are desired as they can be tailored more extensively to optimize their performance. The dedicated structures can be continuous, for example, rather than island-like, and be arranged to completely surround the metrology target to be protected.

The separation of the metrology target patterning device 3 and the product patterning device 2 allows a variety of configurations to be tested. Parameters that can be important include both the form of the surrounding structures and the separation between those structures and the structures to be protected. A balance can need to be struck between protecting the metrology target and leaving enough space around the metrology target to allow it to perform correctly.

FIG. 8 depicts protective structures for metrology targets positioned in the region between the dies and the edge of the substrate, according to one embodiment of the invention. FIG. 8 shows the equivalent arrangement for metrology targets printed in a region 39 around the edge of the substrate outside of dies 23. Again, metrology target 32 is likely to be exposed and vulnerable to attack, while metrology target 34 is protected by clone marks 36.

In one example, although neighboring patterns (either deliberately added protective structures or nearby product features) can serve to protect a metrology target, they can also have a negative impact on performance if cross-talk occurs. It can be difficult to predict where cross-talk of this kind will be a problem.

In one example, a number of different positions for each type of metrology target are tried, and a deduction of which position is more desirable is determined.

In one example, an application is provided (e.g., implemented in software, firmware, or both,) that is arranged to analyze the product pattern and the desired metrology target pattern(s), and determine whether the intended metrology target location is optimal. For example, locations where the nearby product structure is most different to the metrology target are likely to be preferred.

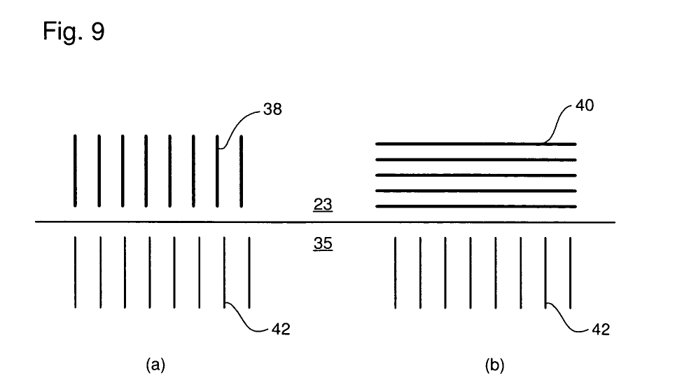

FIG. 9 depicts positioning of metrology targets to minimize cross-talk with product features, according to one embodiment of the invention. FIG. 9 illustrates a simple example of such decision making, which can be built into the metrology target patterning device 3. Here, two product structures, a vertical grating 38 and a horizontal grating 40, are shown near the edge of die 23. Metrology target patterning device 3, taking an input data that includes product structures 38 and 40 (e.g., this can be derived from the data set sent to the product patterning device 2) will position metrology target 42 at position (b) rather than (a), as the similarly oriented grating 38 is more likely to cause cross-talk effects than grating 40.

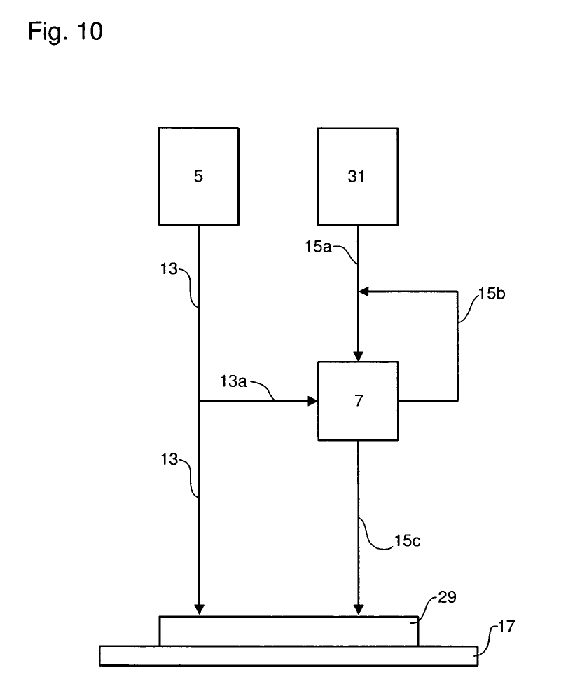

FIG. 10 depicts a lithographic apparatus, according to one embodiment of the invention, comprising a control system for an array of individually controllable elements and a metrology target verification and adaptation device. FIG. 10 shows an embodiment according to an alternative aspect of the invention, comprising a single array of individually controllable elements 17 for patterning both product device structures and metrology target structures onto the substrate W. The array of individually controllable elements 17 is controlled by a control system 29, which is capable of actuating each element according to its address and one or more control signals. In this embodiment, control system 29 is configured to receive control signals comprising two separate data streams: a first data stream from a product pattern controller 5 via data path 13, comprising a product pattern data representing features of a product device to be formed and a second data stream via data path 15c comprising metrology target pattern data representing an intended metrology target pattern and/or an intended metrology target location on the substrate.

In this embodiment, although it can be known what kinds of metrology target are likely to be needed for a given process layer, it can not be clear in advance how best to implement each metrology target for a given product pattern. The separation of the product pattern data from the metrology target pattern data, as described above, allows the implementation of a metrology target verification and adaptation device 7, which is provided to facilitate the introduction of new kinds of metrology target by evaluating a proposed metrology target design and location on the substrate (input, for example, from a metrology target pattern controller 31 via data path 15a) while taking account of the product pattern to be printed (the relevant data being made available via data paths 13a and 15a). If judged necessary, the metrology target verification and adaptation device 7 calculates a suitable correction to either or both of the metrology target pattern or location and sends this correction as a feedback via data path 15b. Once the metrology target verification and adaptation device 7 judges that the likely performance of the metrology target is within acceptable limits, an updated metrology target pattern data is forwarded via data path 15c to control system 29. In this way, the metrology target pattern can be updated in real-time without interrupting the product patterning process. The approach also facilitates the effective introduction of entirely new metrology targets in real time.

According to embodiments of the invention, metrology targets are printed onto the substrate W at the same time as product patterns. This is done to ensure a proper relationship between product structures and metrology targets. If the metrology targets on the mask can be used with inline metrology techniques (e.g., scatterometry), based on inspection of a “latent” image of metrology targets (i.e., metrology target patterns formed on the substrate by exposed radiation only, without any further processing of the substrate), a feedback loop of metrology information (e.g., overlay values) can be used to correct for errors in the imaging process for the next substrate to be processed. In practice, this correction involves modifying one or more so-called “exposure settings,” which can be any tunable parameter associated with elements of the lithography apparatus (including, for example, the illumination system, patterning means and projection system) that can affect image quality (as indicated by the inline readout of the metrology targets). The exposure settings can be parameterized in many different ways and can include, but are not limited to, magnification, translations in the substrate plane, focus, and radiation intensity.

In one example, a next substrate behaves in exactly the same way as the substrate used for correction of the exposure settings. In practice, this may not be the case and substrates within a given batch can vary significantly. This can be due to irregularities in previously formed device layers, or can arise due to other structural variations (for example, those caused by thermal offsets).

In one example, variation within a batch can be dealt with using the following process flow: (a) expose substrate; (b) readout metrology targets (inline); (c) re-work substrate (to prepare it for re-exposure of the product features, which would normally include removing a layer of exposed resist); and, (d) re-expose substrate with optimal exposure settings. The need for the substrate re-working step can severely hamper productivity and can make substrate flow in the factory very complex.

According to an embodiment of the invention, a more efficient optimization of exposure settings can be achieved using a system that can print metrology targets separately from product features. In particular, the present embodiment provides a system wherein a first pattern is printed to the substrate that consists mainly or entirely of metrology targets, without patterns corresponding to product features. Most of the substrate remains un-exposed after this step. An inspection out of the latent image of the metrology targets is then carried in order to measure metrology information (e.g., overlay values, etc.). In one example, “latent image” means an image detectable on the resist on the substrate after exposure with patterned radiation, but prior to any processing or development of the resist (e.g., a post-exposure bake).

In this example, the exposure settings of the lithography apparatus are improved by reference to the information derived in the inspection step. The product features are then exposed onto the substrate without having to carry out any re-working of the substrate. This is possible because the areas destined for product features were not affected by the metrology target writing step. Avoiding the re-working step greatly improves productivity and removes the need for additional substrate handling apparatus.

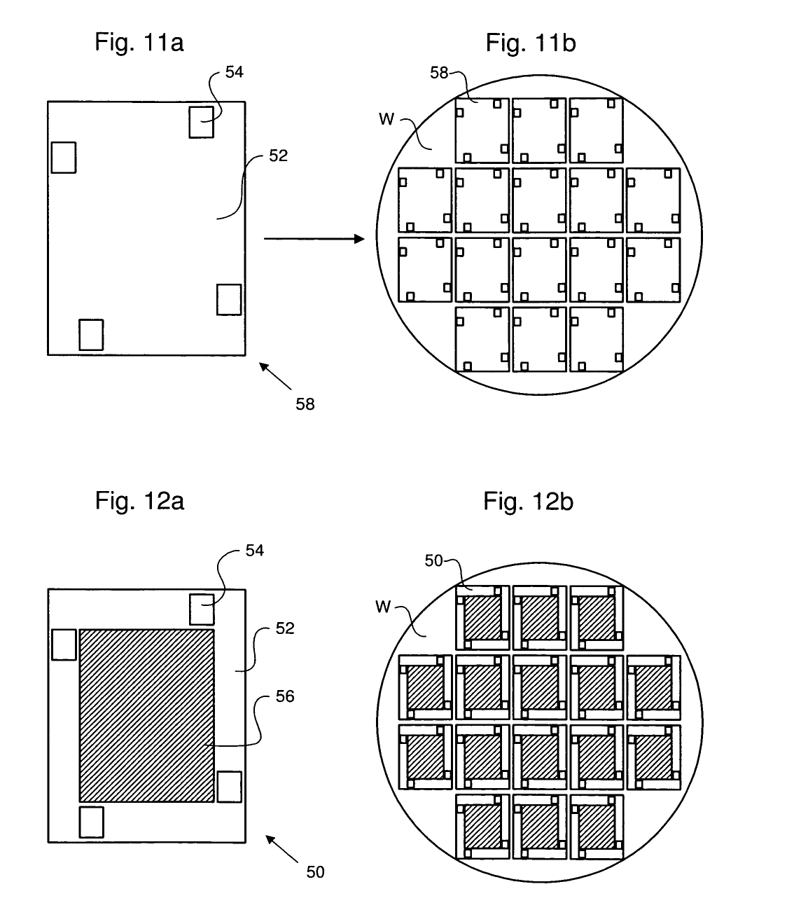

FIGS. 11a and 11b show schematically how such a first exposure pattern might be designed, according to one embodiment of the present invention. FIG. 11a shows a single die after first exposure with four metrology targets 54 around the periphery of the die. FIG. 11b shows how these dies can be distributed over the surface of the substrate W. Although FIG. 11b shows all the dies represented, it one example it can be desired to pattern only a subset of the dies in the first exposure step, leaving the metrology targets associated with the remaining dies to be printed along with the product pattern in a later step (and, possibly, used in a final inspection step to evaluate the quality of the product pattern).

FIGS. 12a and 12b illustrate the pattern exposed on the substrate after the second optimized/compensation exposure has been made, including the product device features, according to one example of the present invention. The pattern corresponds to the same die and collection of dies as FIGS. 11a and 11b, respectively. FIGS. 11 and 12 show the substrate W having a circular form, but it can also be arranged to be rectangular (e.g., when the invention is applied to the manufacture of flat panel displays), or any other shape appropriate in the particular circumstances.

In one example, it may not be appropriate for the final inspection of the substrate (after the product image has been exposed) to be based on the same metrology targets as were used for the initial determination of the optimal exposure settings. Instead, other fields or other metrology targets in the same field can be selected for readout. As a variation (as mentioned above), in another example the second exposure (i.e., the exposure including product structure) can also comprise new metrology targets for use in the final inspection step.

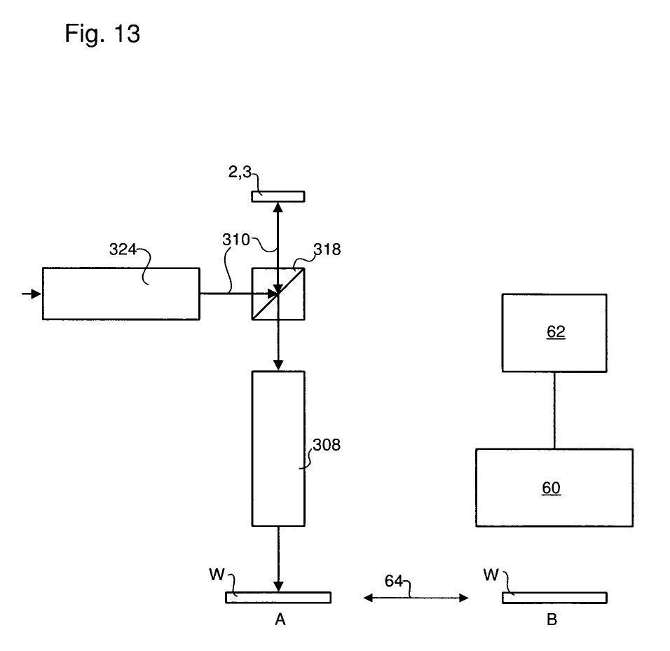

FIG. 13 shows an apparatus suitable for carrying out the above method, according to one embodiment of the present invention. An illumination system 324 directs a projection beam 310 towards a beam splitter 318. The projection beam 310 is then reflected from, and patterned by, a patterning device 2, 3 before being projected by projection system 308 onto a target portion of substrate W. The arrangement shown is intended for use with a maskless patterning device, but an analogous system using masks, such as that depicted in FIGS. 2a and 2b, can also be used without departing from the scope of the invention.

After a first exposure with metrology targets, the substrate W can be moved from a position A, immediately below the axis of the projection system 308, to a position B, which allows access to a metrology inspection device 60. Arrow 64 is provided as a visual aid to show the transition between the positions A and B. In one example, metrology inspection device 60 can operate by scatterometry.

The metrology inspection device 60 is configured to inspect the latent image of metrology marks on the substrate W. The results of this inspection are analyzed in controller 62, which calculates how to modify exposure settings for the illumination system 324, patterning device 2, 3, projection system 308, and any other component that might affect metrology, in order to improve the imaging performance of the lithography apparatus for that particular substrate W.

In one example, when the lithographic apparatus comprises a number of optical columns, which can each comprise distinct patterning devices 2, 3 and projection systems 308, etc., multiple sets of exposure settings (one set for each optical column) may need to be optimized/compensated, for example, by inspecting metrology targets generated by each column. Once this process is complete, the substrate W is replaced in the exposure position A ready for exposure of the actual product pattern with the optimized/compensated exposure settings.

In the example shown in FIG. 13, the substrate W moves between an exposure position and a metrology position. In another example, a metrology target inspection 60 device forms part of the projection system 308, or is located adjacent thereto, in such a way that the latent metrology target images can be inspected while the substrate W is in an exposure position, beneath the axis of the projection system 308.

The embodiment shown in FIG. 13 allows true exposure settings optimization on an individual substrate basis (i.e., optimization for a given substrate is based on measurements of metrology targets on that substrate rather than on measurements of metrology targets on preceding substrates). This provides an efficient way of dealing with situations in which substrate properties vary substantially within a batch. More generally, the approach can also be used to provide an improved optimization even when this is not the case and/or for cost-saving purposes can allow tolerances related to substrate regularity to be relaxed. This arrangement can also enhance product yield per substrate.

In one example, for new product-starts, a “send-ahead” substrate (which is a calibration-only substrate sent in advance to determine suitable exposure parameters for the product substrates to follow) is no longer required. The spatial extent and location of the metrology targets necessary for determining optimal exposure settings are such that there is no great reduction in the space available for the product features.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

What is claimed is:

1. A device manufacturing method, comprising:
(a) performing a first exposure using a first set of exposure settings to expose a substrate with a first pattern that forms a set of one or more metrology targets;
(b) inspecting a latent image of the one or more metrology targets formed on the substrate;
(c) deriving from the latent image a second set of exposure settings; and
(c) performing a second exposure using the second set of exposure settings to expose the substrate to a second pattern that forms a set of one or more product device features.

2. The method of claim 1, wherein step (b) comprises:
using as the latent image a detectable pattern left on a resist layer on the substrate after the resist layer has been exposure to the first pattern, but before any further processing or development of the resist layer.

3. The method of claim 1, further comprising:
carrying out the first exposure and the second exposure on a same resist layer of the substrate.

4. The method of claim 1, further comprising:
using at least one of image magnification, image translation, image focus, and radiation intensity as the exposure settings.

5. The method of claim 1, further comprising:
forming only metrology targets with the first pattern.

6. The method of claim 1, further comprising:
forming only product device features with the second pattern.

7. The method of claim 1, further comprising:
forming a first set of metrology targets with the first pattern; and
forming a second set of metrology targets, which are different from the first set, with the second pattern.

8. The method of claim 1, wherein the second set of exposure settings are compensation exposure settings.

9. A lithographic apparatus, comprising:
an illumination system that supplies a beam of radiation;
a control system that controls an array of individually controllable elements that pattern the beam;
a projection system that projects the patterned beam onto a target portion of a substrate; and
a detection system that detects features formed on the substrate,
wherein a first set of exposure settings are used by the control system to control the individually controllable elements during a first exposure to expose the substrate with a first pattern that forms a first set of one or more metrology targets,
wherein the detection system detects a latent image of the first set of the one or more metrology targets and generates a second set of exposure settings therefrom,
wherein the second set of exposure settings are used by the control system to control the individually controllable elements during a second exposure to expose the substrate with a second pattern that forms a second set of one or more metrology targets.

10. The lithographic apparatus of claim 9, wherein the latent image comprises a detectable pattern left on a resist layer on the substrate after the resist layer has been exposure to the first pattern, but before any further processing or development of the resist layer.

11. The lithographic apparatus of claim 9, wherein a same resist layer of the substrate is used to carryout the first exposure and the second exposure.

12. The lithographic apparatus of claim 9, wherein the exposure settings include at least one of image magnification, image translation, image focus, and radiation intensity.

13. The lithographic apparatus of claim 9, wherein the first pattern comprises metrology targets only.

14. The lithographic apparatus of claim 9, wherein the second pattern comprises product device features only.

15. The lithographic apparatus of claim 9, wherein the first pattern comprises a first set of metrology targets and the second pattern comprises a second set of metrology targets, different from the first set.

16. The lithographic apparatus of claim 9, wherein the second set of exposure settings are compensation exposure settings.
